(19) United States
(12) Patent Application Publication
(10) Pub. No.: US 2013/0202510 A1
(43) Pub. Date: Aug. 8, 2013

(54) Method for Removal of Sulfur Using Cuprous Oxide

(71) Applicants: Vladislav Ivanov Kanazirev, Arlington Heights, IL (US); Jayant K. Gorawara, Buffalo Grove, IL (US)

(72) Inventors: Vladislav Ivanov Kanazirev, Arlington Heights, IL (US); Jayant K. Gorawara, Buffalo Grove, IL (US)

(73) Assignee: UOP LLC, Des Plaines, IL (US)

(21) Appl. No.: 13/367,143

(22) Filed: Feb. 6, 2012

(51) Int. Cl. B01D 53/48; B01J 39/00; B01D 53/52

(52) U.S. Cl. 423/230; 423/244.06; 423/244.02; 210/660

(57) ABSTRACT

A method of removing H₂S, a mercaptan, and/or COS from a fluid stream is presented. The method comprises contacting the fluid stream with a sorbent comprising Cu₂O.

### FIELD OF THE INVENTION

The disclosure relates in general to the removal of contaminants from hydrocarbon liquid and gas streams. In certain embodiments, the invention relates to the use of a copper-based sorbent to remove sulfur from hydrocarbon streams. In certain embodiments, the invention relates to the use of a cuprous oxide sorbent resistant to further copper reduction to remove sulfur compounds from hydrocarbon streams.

### BACKGROUND OF THE INVENTION

The removal of sulfur compounds from gas and liquid streams is an important process in the hydrocarbon industry. In many processes, high levels of sulfur compounds removal, including trace amounts, are required to protect downstream catalysts and other components.

Supported copper adsorbents are known in the prior art for removing sulfur compounds from hydrocarbon streams. Prior art adsorbents containing metallic copper (Cu) and related methods, however, cannot achieve hydrocarbon streams with low residual sulfur concentration due to thermodynamic limitations of reaction (1).

Cu+H₂S→CuS+H₂ (1)

While prior art adsorbents containing cupric oxide (CuO) are not restricted by thermodynamics, such absorbents release large amounts of water at start up due to reduction to a lower valent state by the components of the hydrocarbon stream by reactions 2-4.

2CuO+H₂→Cu₂O+H₂O (2)

CuO+H₂S→CuS+H₂O (3)

2CuO+Alkane→Cu₂O+H₂O+Alkene (4)

In addition, other undesirable compounds may be generated by reaction with cupric oxide. For example, if mercaptans are present in the hydrocarbon stream, disulfides will be generated in addition to water by reaction (5).

2CuO+2RSH→RS—SR+H₂O+Cu₂O (5)

Accordingly, it would be an advance in the state of the art to provide a sorbent capable of producing a hydrocarbon stream with very low levels of sulfur without the production of large amounts of water or other undesired components at start up.

### SUMMARY OF THE INVENTION

A method of removing H₂S, a mercaptan, and COS from a fluid stream is presented. The method comprises contacting the fluid stream with a sorbent comprising Cu₂O.

### DETAILED DESCRIPTION OF PREFERRED EMBODIMENTS

The invention is described in preferred embodiments in the following description. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The terms sorbent, adsorbent, and absorbent as used herein refer to the ability of a material to take in or soak up liquid or gas components on the surface thereof or to assimilate such components into the body thereof.

Applicants' sorbent comprises an active copper phase disposed within a support material. In one embodiment, the active copper phase comprises cuprous oxide (Cu₂O) with no or substantially no cupric oxide (CuO) and with no or substantially no metallic copper (Cu). In one embodiment, the cuprous oxide in Applicants' sorbent is resistant to reduction to metallic copper. As such, Applicants' sorbent avoids the moisture generating reactions of prior art adsorbents, avoids the thermodynamic-limiting reactions preventing high levels of sulfur removal, and avoids the release of heat from the reduction of Cu₂O to metallic copper.

In one embodiment, Applicants' sorbent comprises cuprous oxide (Cu₂O) disposed within a support material. In various embodiments, the sorbent comprises cuprous oxide (Cu₂O) and a halide salt disposed within a support material.

The cuprous sulfide-containing sorbent scavenges hydrogen sulfide by reaction (6) and mercaptans by reaction (7) without the formation of disulfides that would result from cupric sulfide-containing sorbents. As such, Applicants' sorbent forms no disulfide compounds.

Cu₂O+H₂S→Cu₂S+H₂O (6)

Cu₂O+2RSH→2CuSR+H₂O (7)

In various embodiments, the support material is a metal oxide selected from the group consisting of alumina, silica, silica-aluminas, silicates, aluminates, silico-aluminates such as zeolites, titania, zirconia, hematite, ceria, magnesium oxide, and tungsten oxide. In one embodiment, the support material is alumina. In some embodiments, the support material is carbon or activated carbon. In certain embodiments, Applicants' sorbent does not comprise a binder.

In various embodiments, the alumina support material is present in the form of transition alumina, which comprises a mixture of poorly crystalline alumina phases such as “rho,” “chi” and “pseudo gamma” aluminas which are capable of quick rehydration and can retain substantial amounts of water in a reactive form. An aluminum hydroxide Al(OH)₃, such as Gibbsite, is a source for preparation of transition alumina. The prior art industrial process for production of transition alumina includes milling Gibbsite to 1-20 microns particle size followed by flash calcination for a short contact time as described in the patent literature such as in U.S. Pat. No. 2,915,365. Amorphous aluminum hydroxide and other naturally found mineral crystalline hydroxides e.g., Bayerite and Nordstrandite or monoxide hydroxides, AlOOH, such as Boehmite and Diaspore can be also used as a source of transition alumina. In one embodiment, the BET surface area of this transition alumina material is about 300 m²/g and the average pore diameter is about 45 angstroms as determined by nitrogen adsorption.

In various embodiments, a solid oxysalt of a transition metal is used as a component of the sorbent. “Oxysalt,” by definition, refers to any salt of an oxyacid. Sometimes this definition is broadened to “a salt containing oxygen as well as a given anion.” FeOCl, for example, is regarded as an oxysalt according this definition.

In certain embodiments, the oxysalt comprises one or more copper carbonates.

Basic copper carbonates, such as Cu₂CO₃(OH)₂, can be produced by precipitation of copper salts, such as Cu(NO)₃, CuSO₄ and CuCl₂, with sodium carbonate. In one embodiment, a synthetic form of malachite, a basic copper carbonate, produced by Phibro Tech, Ridgefield Park, N.J., is used as a component of the sorbent.

Depending on the conditions used, and especially on washing the resulting precipitate, the final material may contain some residual product from the precipitation process. In the case of the CuCl₂ raw material, sodium chloride is a side product of the precipitation process. It has been determined that a commercially available basic copper carbonate that had both residual chloride and sodium, exhibited lower stability towards heating and improved resistance towards reduction than other commercial basic copper carbonates that were practically chloride-free.

In one embodiment, the particle size of the basic copper carbonate particles is approximately in the range of that of the transition alumina, namely 1-20 microns. In other embodiments, the sorbent comprises the oxysalt Azurite, Cu₃(CO₃)₂(OH)₂. In other embodiments, the sorbent comprises an oxysalt of copper, nickel, iron, manganese, cobalt, zinc or a mixture thereof.

In certain embodiments, the sorbent is produced by calcinating a mixture of an inorganic halide additive and basic copper carbonate for a sufficient period of time to decompose the basic copper carbonate into an oxide. In various embodiments, the inorganic halides are sodium chloride, potassium chloride or mixtures thereof. In certain embodiments, the inorganic halides are bromide salts. In various embodiments, the chloride content in the sorbent ranges from 0.05 mass percent to 2.5 mass percent. In various embodiments, the chloride content in the sorbent ranges from 0.3 to 1.2 mass percent. The copper oxide-based sorbent that contains the halide salt exhibits a higher resistance to reduction than does a similar sorbent that is made without the halide salt. In certain embodiments, the halide is chloride.

In one embodiment, the sorbent is produced by conodulizing basic copper carbonate with alumina followed by curing and activation. In various embodiments, the nodulizing, or agglomeration, is performed in a pan or a drum. The materials are agitated by the oscillating or rotating motion of the nodulizer while spraying with water to form beads. In certain embodiments, the water is replaced with weak sodium chloride in a concentration sufficient to achieve up to 0.8% chloride in the final dried product. In one embodiment, the beads are cured at about 60° C. and dried in a moving bed activator at a temperature at or below about 175° C. In other embodiments, the sorbent beads are formed by extrusion.

In one embodiment, the sorbent beads are calcinated at greater than 350° C. In certain embodiments, the sorbent beads are calcinated at between about 250° C. to about 450° C. In one embodiment, the sorbent beads are calcinated in an atmosphere of nitrogen gas at about 400° C. The heat decomposes the copper in the copper carbonate to produce cupric oxide (CuO).

In various embodiments, and depending on the application, the sorbent comprises about 5 mass percent to about 85 mass percent copper, calculated as CuO on a volatile-free basis. In various embodiments, the sorbent comprises about 20 mass percent to about 70 mass percent copper, calculated as CuO on a volatile-free basis. In various embodiments, the sorbent comprises about 30 mass percent to about 60 mass percent copper, calculated as CuO on a volatile-free basis. In one embodiment, the sorbent comprises about 32 mass percent to about 34 mass percent copper, calculated as CuO on a volatile-free basis. In one embodiment, the sorbent comprises about 38 mass percent copper, calculated as CuO on a volatile-free basis. In one embodiment, the sorbent comprises about 40 mass percent copper, calculated as CuO on a volatile-free basis. In one embodiment, the sorbent comprises about 70 mass percent copper, calculated as CuO on a volatile-free basis.

In certain embodiments, the sorbent has a diameter (for spherical beads) or maximum width (for irregular shaped beads) of about 1 mm to about 10 mm. In certain embodiments, the sorbent has a diameter or maximum width of about 1.5 mm to about 3 mm.

The cupric oxide (CuO) is exposed to a reducing environment to form cuprous oxide (Cu₂O). In various embodiments, the reducing environment comprises hydrogen gas (H₇), carbon monoxide gas (CO), or a combination thereof. In various embodiments, the reducing environment comprises a hydrocarbon in gas or liquid form. In certain embodiments, the hydrocarbon is methane (CH₄) or petroleum fractions. In various embodiments, the reduction occurs at between about 100° C. to about 300° C., depending on the reducing agent and the exposure time. In various embodiments, the reduction occurs at between about 100° C. to about 200° C. In various embodiments, the reduction occurs at between about 120° C. to about 190° C. In certain embodiments, the conversion of CuO to Cu₂O is monitored using x-ray diffraction. In certain embodiments, the conversion of CuO to Cu₂O is monitored by the color change in the material from black (indicating CuO) to a beige or yellowish color (indicating Cu₂O). In certain embodiments, the conversion of CuO to Cu₂O is complete, such that the final sorbent comprises no CuO or substantially no CuO.

The copper in the sorbent is more resistant to reduction due to the halide salt disposed within the sorbent. As such, reduction first to cupric oxide (CuO), then cuprous oxide (Cu₂O), is more difficult. This resistance to reduction also prevents the formation of metallic copper when the sorbent is used to scavenge sulfur from a hydrocarbon stream.

The following Example is presented to further illustrate to persons skilled in the art how to make and use the invention. This Example is not intended as a limitation, however, upon the scope of Applicant's invention.

### EXAMPLE

A mixture of a copper oxysalt and a support material is provided. In one embodiment, the copper oxysalt is basic copper carbonate, Cu₂(OH)₂CO₃ and the support material is alumina powder capable of rehydration. In different embodiments, the copper content of the mixture, calculated as CuO on a volatile-free basis, is between about 5 mass percent and about 85 mass percent. In different embodiments, the copper content of the mixture is about 32 mass percent, 40 mass percent, or 70 mass percent.

Green sorbent beads are formed from the mixture. As used herein, “green sorbent beads” refer to beads containing the copper oxysalt before any copper reduction and “activated sorbent beads” refer to beads where at least a portion of the copper has been converted to copper oxide. In one embodiment, the beads are formed by nodulizing the mixture in a rotating pan nodulizer while spraying with a liquid. In one embodiment, the liquid comprises water. In one embodiment, the liquid comprises a solution of water and a halide salt. In one embodiment, the halide salt is sodium chloride. The amount of sodium chloride in solution is selected based on the desired ratio of the various active copper components in the final product. In one embodiment, the solution comprises an about 1% to about 3% solution of sodium chloride.

In another embodiment, the green sorbent beads are formed by agglomeration. in another embodiment, the green sorbent beads are formed by extrusion. Those skilled in the art will appreciate that other methods may be performed to produce regular- or irregular-shaped beads that fall within the scope of Applicants' invention.

The green sorbent beads are cured and dried. In one embodiment, the curing occurs at about 60° C. In one embodiment, the beads are dried in a moving bed activator at temperatures at or below 175° C. In one embodiment, the activated sorbent beads comprise about 0.5 mass percent to about 0.8 mass percent chloride.

The copper carbonate in the sorbent beads is converted to copper oxide. In one embodiment, the conversion comprises decomposition in an atmosphere of air and combustion gases. In one embodiment, the decomposition occurs at about 300° C. In certain embodiments, the decomposition to CuO in the sorbent beads is complete (i.e., all or substantially all copper is decomposed to CuO).

The CuO in the sorbent beads is reduced to Cu₂O by exposure to a reducing environment. In various embodiments, the reducing environment comprises hydrogen gas (H₂), carbon monoxide gas (CO), or a combination thereof. In various embodiments, the reducing environment comprises a hydrocarbon in gas or liquid form. In certain embodiments, the hydrocarbon is methane (CH₄) or petroleum fractions. In various embodiments, the reduction takes place at a temperature of about 120° C. to about 190° C. In certain embodiments, the reduction to Cu₂O in the sorbent beads is complete (i.e., all or substantially all CuO is reduced to Cu₂O such that the sorbent comprises no CuO). In certain embodiments, the reduction is monitored by x-ray diffraction or color sensors.

The sorbent is placed in a hydrocarbon fluid (i.e., gas or liquid) stream containing sulfide impurities. In one embodiment, the hydrocarbon stream comprises hydrogen sulfide (H₂S), a mercaptan (RSH), COS, or a combination thereof. In one certain embodiments, where the stream comprises a mercaptan, the sulfide impurities are scavenged without the formation of disulfide compounds. In one embodiment, the temperature of the stream is between about 150° C. to about 200° C.

The described features, structures, or characteristics of the invention may be combined in any suitable manner in one or more embodiments. In the above description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. In other words, the present invention may be embodied in other specific forms without departing from its spirit or essential characteristics. The described implementations are to be considered in all respects only as illustrative and not restrictive. The scope of the invention should, therefore, be determined not with reference to the above description, but instead should be determined with reference to the pending claims along with their full scope or equivalents, and all changes which come within the meaning and range of equivalency of the claims are to be embraced within their full scope.

What is claimed is:

1. A method of removing from a fluid stream at least one impurity selected from the group consisting of H₂S, a mercaptan, and COS, comprising contacting said fluid stream with a sorbent comprising Cu₂O.

2. The method of claim 1, wherein said sorbent comprises no CuO.

3. The method of claim 2, wherein said sorbent comprises no metallic copper.

4. The method of claim 1, wherein said sorbent further comprises at least one halide salt.

5. The method of claim 4, wherein said at least one halide salt comprises a chloride and said chloride comprises from about 0.05 to about 2.5 mass percent of said sorbent.

6. The method of claim 4, wherein said at least one halide salt comprises a chloride and said chloride comprises from about 0.3 to about 1.2 mass percent of said sorbent.

7. The method of claim 1, wherein said sorbet further comprises a support material.

8. The method of claim 7, wherein said support material is porous.

9. The method of claim 8, wherein said support material comprises alumina.

10. The method of claim 1, wherein said sorbet comprises a copper content of between about 5 mass percent and 85 mass percent, calculated as CuO on a volatile-free basis.

11. The method of claim 1, wherein said sorbet comprises a copper content of between about 30 mass percent and 60 mass percent, calculated as CuO on a volatile-free basis.

12. The method of claim 1, wherein said sorbent has a diameter (or a maximum width) of between about 1 mm to about 10 mm.

13. The method of claim 12, wherein said sorbent has a diameter (or a maximum width) of between about 1.5 mm to 3 mm.

14. The method of claim 1, wherein said Cu₂O is formed by reduction of CuO at a temperature between about 100° C. and about 300° C.

15. The method of claim 14, wherein said reduction occurs in an environment comprising a hydrocarbon.

16. The method of claim 14, wherein said reduction occurs in an environment comprising a gas at a temperature between about 100° C. and about 200° C.

17. The method of claim 14, wherein said reduction occurs in an environment comprising a reducing agent from the group consisting of H₂, CO, CH₄, a petroleum fraction, or a combination thereof.

18. The method of claim 1, wherein an impurity of said at least one impurity comprises a mercaptan and the method further comprising forming no disulfide compounds.
